(19) United States
(12) Patent Application Publication
(10) Pub. No.: US 2006/0075493 A1
(43) Pub. Date: Apr. 6, 2006

(54) Sending a message to an alert computer

(76) Inventors: Alan H. Karp, Palo Alto, CA (US); Marc D. Stiegler, Kingman, AZ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/958,276

(22) Filed: Oct. 6, 2004

(51) Int. Cl. G06F 12/14

(52) U.S. Cl. 726/22

(57) ABSTRACT

A computer application is run within a restricted user account including permissions to access contact information for at least one computer system. If a computer virus infects the application, the application uses the contact information to send a message to only authorized computers including the at least one alert computer.

### BACKGROUND

In the past few years, computer viruses have caused damage to computer systems throughout the world. A computer virus is a program capable of operation on a computer system, such as a personal computer, that is self-replicating and that can “infect” other programs by modifying them or their environment such that a call to an infected program results in an action that the user may not like.

Computer systems today typically run operating systems having user accounts for users of the systems. A user logs into the computer system under a user account and has permissions to add, edit, delete or use most of the resources available in the computer system. Additionally, applications running in the user's account have the same permissions as the user. This arrangement presents a computer virus with a doorway to most of the resources in the computer system. For instance, if an application is infected by a virus, the virus is able to spread to any resource that the application may access including other computer systems located on a network. For example, a virus may use e-mail resources to spread itself to every other user listed in the user's e-mail address book or contact list. Also, a virus may monitor a user's actions to collect confidential user information, such as passwords and credit card information, and send that information through a network to another computer system. Conventional virus detection software may be unable to stop these types of virus attacks because, in most instances, the user will not know that a virus attack is occurring.

### SUMMARY

According to an embodiment, a method includes configuring a restricted user account to include permission to access contact information for sending a message to at least one alert computer. An application is run within the restricted user account, such that a computer virus infecting the application uses the contact information to send the message to only authorized computers including the at least one alert computer.

### BRIEF DESCRIPTION OF THE DRAWINGS

Embodiments of the invention are illustrated by way of example and without limitation in the accompanying figures in which like numeral references refer to like elements, and wherein:

FIG. 1 shows a block diagram of a system for detecting a computer virus in accordance with an embodiment of the invention;

FIG. 2 shows a Venn diagram of user accounts in accordance with an embodiment of the invention;

FIG. 3 shows a table of user account permissions in accordance with an embodiment of the invention;

FIG. 4 shows a block diagram of a system for confining an application in accordance with an embodiment of the invention;

FIG. 5 shows a flow diagram of an operational mode of a system for detecting a computer virus in accordance with an embodiment of the invention;

FIG. 6 shows a flow diagram of an operational mode of a system for detecting a computer virus in accordance with another embodiment of the invention;

FIG. 7 shows a flow diagram of an operational mode of a system for detecting a computer virus in accordance with another embodiment of the invention;

FIG. 8 shows a flow diagram of an operational mode of a system for detecting a computer virus in accordance with another embodiment of the invention; and

FIG. 9 shows a schematic diagram of a computer system in which embodiments of the invention may be implemented.

### DETAILED DESCRIPTION

For simplicity and illustrative purposes, the principles of the invention are described by referring mainly to examples thereof. In the following description, numerous specific details are set forth in order to provide a thorough understanding of the invention. It will be apparent however, to one of ordinary skill in the art, that the invention may be practiced without limitation to these specific details. In other instances, well known methods and structures have not been described in detail so as not to unnecessarily obscure the invention.

Throughout the present disclosure, reference is made to a restricted user account. The restricted user account may be defined as an account created within a user's login account and provided with access to fewer resources than the user's login account. For example, a restricted user account may have permissions to access an executable file, any other file necessary to complete a task and predetermined restricted connections to other computer systems by way of e-mail and network connection systems. Once a restricted user account is created, an application may run in the restricted user account and access to the same resources that the restricted user account may access.

Throughout the present disclosure, reference is made to an alert computer. The alert computer may be defined as any type of computer system or application running on a computer system configured to alert a person, computer or another application that a virus is attempting to spread to other computer systems. The alert computer may be protected from viruses yet open to attack from a virus in a manner to allow the alert computer to receive e-mail and network messages from other computers. The alert computer may be configured to analyze incoming e-mail and network messages to determine if the messages contain a virus or may be configured treat all incoming messages as signifying a virus attack. If one of the messages contains a virus, the alert computer may be configured to notify an authority or multiple authorities, such as, a network administrator, software engineer or any other person who would benefit from knowing about a virus attempting to propagate. Alternatively, the alert computer may be configured to take appropriate action or to notify another computer system or application to take appropriate action, such as, notifying a user that an application is infected with a virus, directing the user to an anti-virus software site or advertisement, attempting to remove the virus remotely or directing the user to run an anti-virus software program.

Reference is also made to an authorized computer. The authorized computer may be defined as any type of computer system or application running on a computer system that is authorized to communicate with a user's application. For example, a user may have determined that the application communicates with a plurality of predetermined computer systems. Those predetermined computer systems are the authorized computers. In this example, in addition to the user-selected authorized computers, one or more alert computers are also included in a list of authorized computers. In another example, the authorized computers may not be selected be the user. In this example, the authorized computers include one or more alert computers only.

Throughout the present disclosure, reference is made to contact information. Contact information may be defined as any information used for sending a message to another computer. Contact information includes e-mail addresses, contact lists (a collection of e-mail addresses), network addresses, or any other information used for sending a message to another computer. Contact information may be stored in a location accessible to a restricted user account. For example, a contact list, having an e-mail address of the alert computer may be stored in a directory available to a restricted user account.

In an example, an application is running in a restricted user account on a computer system. The restricted user account, and likewise the application, may have read only access to an executable file which started the application and read/write access to support files or directories containing the support files for running the application. Additionally, the restricted user account has access to contact information of an alert computer. If the application is infected with a virus, the virus may attack only the files accessible to the restricted user account. Additionally, the virus may attempt to spread or propagate itself by sending an e-mail to every e-mail address listed in the user's contact list. These viruses are sometimes referred to as a “Typhoid Mary” virus. However, the restricted user account has access to a contact list including contact information for only the alert computer or multiple alert computers. Therefore, the virus will send an e-mail only to the alert computer(s). The alert computer may be configured to notify a person, computer or application in response to receiving the e-mail or in responses to discovering, by analyze, that the e-mail is infected with a virus. Alternately, the alert computer may be configured to disinfect the virus remotely or by way of instruction to the user of the application.

In another example, a virus may attempt to send information by way of messages to other computer systems. These viruses may include Spyware, Trojan Horses or Worms designed to collect and send a user's information to another computer system. However, the restricted user account has access to contact information for only one or more alert computers. For example, the contact information includes a network address for an alert computer. A network connection system available to the restricted user account uses the network address and a re-addresser to direct all messages to the alert computer or one of the authorized computers. If the virus attempts to send a message to a computer with a network address other than the network address of the alert computer or one of the authorized computers, the re-addresser intercepts the message and changes the destination address so that the message will be sent to the alert computer. The re-addresser may also be configured to record the original destination address for forensic use. Additionally, the re-addresser may be configured to allow messages to authorized computers other than the alert computer. The alert computer may be configured to notify a person, computer or application in response to receiving the message or in responses to discovering, by analyze, that the message contains illicit information. Alternately, the alert computer may be configured to disinfect the virus remotely or by way of instruction to the user of the application.

As stated above, the re-addresser may be configured to allow messages to authorized computers other than the alert computer. This example accounts for situations wherein a user would like to access a remote resource using the application running in the restricted user account. Without this provision for accessing authorized computers, a user may be denied access to information such as a particular website.

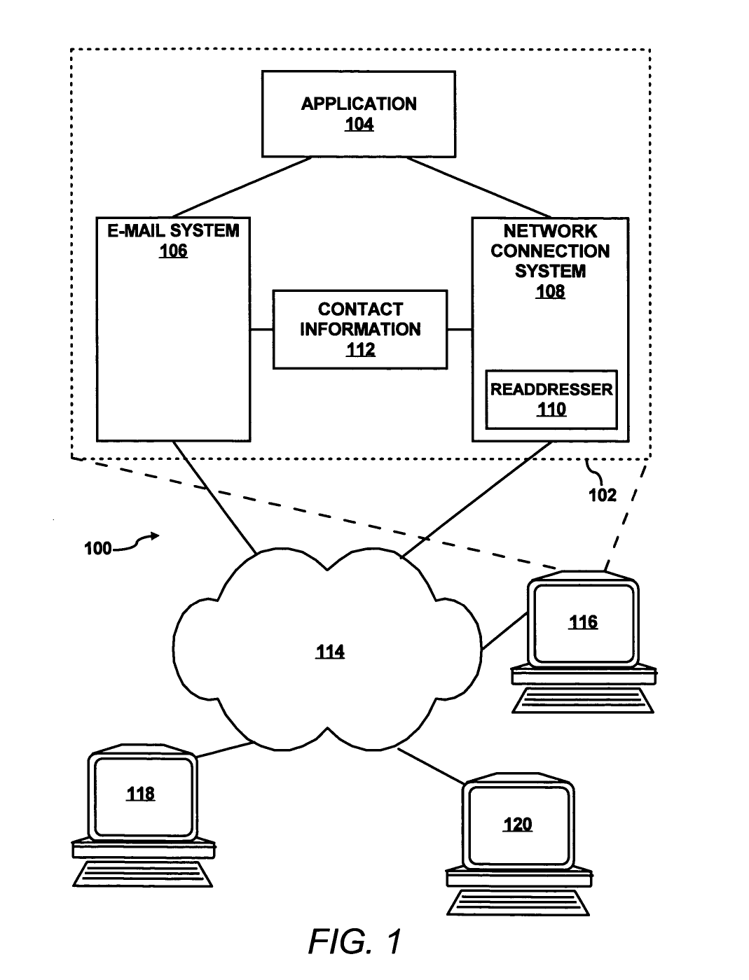

With reference first to FIG. 1, there is shown a block diagram of a system 100 for detecting a computer virus. The system 100 includes a plurality of computer system 116, 118 and 120 connected via a network 114. The computer system 118 may be an alert computer or another type of authorized computer. The computer system 116 includes a restricted user account 102 and an application 104 confined to run within the restricted user account 102. That is, the permissions of the application 104 to access system resources are the same as the permissions of the restricted user account 102. The application 104 may be permitted to access an e-mail system 106 and a network connection system 108.

A re-addresser 110 monitors messages sent through the network connection system 108. The re-addresser 110 may be located outside of the restricted user account 102 such that a virus running inside of the restricted user account 102 does not have access to the re-addresser 110. Contact information 112 may also be available to both the e-mail system 106 and the network connection system 108 which both use the contact information 112 to send messages.

The contact information 112 may include one or more e-mail addresses and/or one or more network addresses assigned to only an alert computer 118 and possibly other alert computers connected to the network 114. Therefore, if the application 104 is infected with a computer virus, the application 104 may use the contact information 112 to send messages only to the alert computer 118 or other alert computers. The restricted user account 102, and the application 104 confined therein, is permitted to use available resources which include the e-mail system 106 and the network connection system 108. In this manner, the application 104 is confined to communication through those resources.

With regards to the e-mail system 106, the application 104 may send messages by way of e-mail to any user on the network 114. However, the contact information 112 in the restricted user account 102 may include a contact list having one or more e-mail addresses of the alert computer 118. In instances of a “Typhoid Mary” virus attack on the application 104, messages or e-mail may be sent to the e-mail addresses listed in the contact list which includes e-mail addresses for the alert computer 118. Upon receiving an e-mail, the alert computer 118 may determine that the application 104 has been attacked by a virus.

With regards to the network connection system 108, the application 104 may attempt to send messages through one of several network protocol transports such as TCP/IP, UDP, IPX/SPX or the like. For example, a virus may have infected the application 104 to send a user's credit card information to a predetermined network address. However, the re-addresser 110 is configured to monitor message transmissions at the network connection system 108, and readdress messages to a network address in the contact information 112 which addresses the alert computer 118. In one example, the re-addresser 110 may be configured to readdress every message without performing a network address determination. In another example, the re-addresser 110 determines whether a message is addressed to the alert computer 118 and re-addresses the message if it is not.

The re-addresser 110 may be implemented in a variety of manners, including but not limited to: providing a separate IP stack per process and configuring the IP stack to deliver messages to the network address of the alert computer 118; providing a separate routing table per process and configuring the routing table to include network addresses of the alert computer 118; filtering and rerouting messages to the alert computer 118 based upon user identification; and modifying a SOCKS proxy to redirect traffic to the alert computer 118.

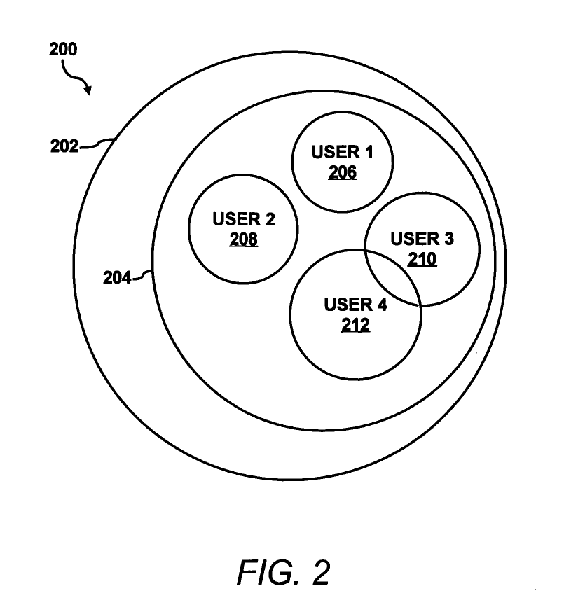

With reference now to FIG. 2, there is shown a Venn diagram 200 of a user account and restricted user accounts in accordance with an example of a computer system. An administrative account 202 may have access to all resources available in a computer system while a user account 204 may have access to all resources available to that particular user. User accounts typically have access to fewer resources than the administrative account 202. However, many user accounts may have access to all resources available in a computer system thus increasing the need for additional protections. The Venn diagram 200 also includes four smaller circles representing four restricted user accounts 206-212 having access to a predetermined set of resources. The first restricted user account 206 has access to the fewest number of resources. For example, the first restricted user account 206 may have access to a single executable file or application. The second restricted user account 208 has access to more resources while the third restricted user account 210 has access to even more resources. In the Venn diagram 200, the forth restricted user account 212 has access to the most systems resources although access is limited to a subset of the resources available to the user which itself is a subset of resources available in the computer system.

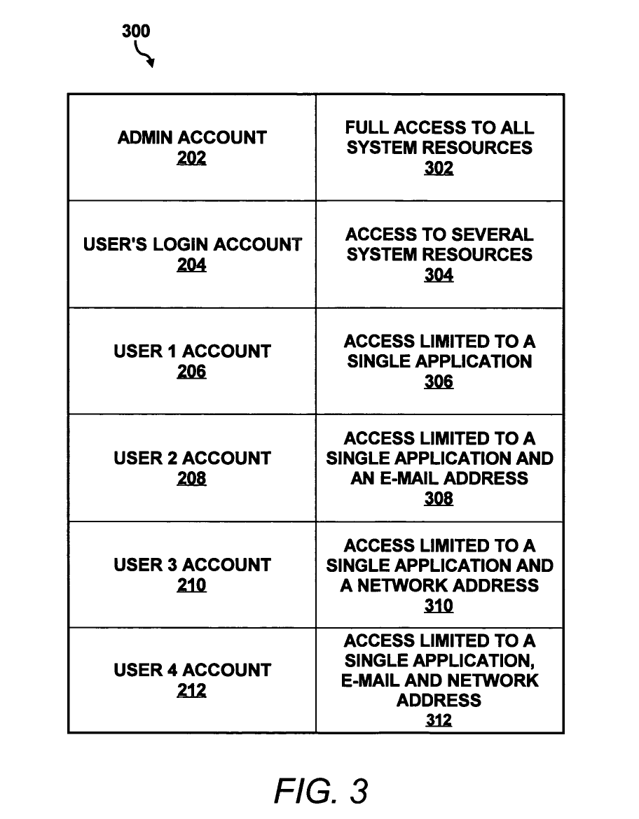

FIG. 3 shows a table 300 of user account permissions in accordance with the Venn diagram of FIG. 2. The administrative account 202 has access to all systems resources, shown in entry 302, in the computer system. The user account 204, or the user's login account, has access to several system resources, shown in entry 304. The system resources may be designated by the administrator of the system. For example, the administrator may determine that a particular user needs access to all text files in certain folders but should not have access to any files containing financial information while an administrator of a company should have access to any file containing financial information but not have access to any file containing confidential client information. The administrator may designate permissions to user accounts accordingly.

For example, the administrator may create a list of resources identifying resources available to the user account 204 and the restricted user accounts 206-212. The list of resources may be stored in a table, database or any data structure. One example of a list of resources is an access control list. The access control list includes entries identifying the resources in a computer system, the user accounts in the computer system, and permissions of the user accounts to access the resources. That is, the access control list maintains a list of resources available to each user account in the computer system. A list of resources that is a subset of the access control list may be generated for a restricted user account, which has permissions to a limited number of resources in the computer system. In one example, each restricted user account may have its own list of resources, and the access control list may include each of those lists. One of ordinary skill in the art would recognize that the list of resources may be stored in a variety of manners.

Referring again to FIG. 3, the first restricted user account 306 has access to a single application, shown in entry 306. The first restricted user account 206 may have been created to run a single executable file, such as, a game, calculator or any other program that runs as a single application. The second restricted user account 208 has access to a single application and contact information, including an e-mail address, shown in entry 308. The second restricted user account 208 may have been created to run a word processor and notify an alert computer if attacked by a virus that propagates by way of e-mail. The third restricted user account 210 has access to a single application and contact information, including a network address, shown in entry 310. The third restricted user account 210 may have been created to run a spread sheet program and notify an alert computer if attacked by a virus that collects and transmits a user's information to another computer system. The fourth restricted user account 212 has access to a single application and contact information, including an e-mail address and a network address, shown in entry 312. The fourth restricted user account 212 may have been created to run the application 104 and notify the alert computer 118 using the contact information 112 if attacked by particular viruses. The description of the restricted user accounts above are for illustrative purposes only. One of ordinary skill in the art would recognize that the any number of restricted user accounts may be created having a plurality of possible permission settings.

For instance, multiple restricted user accounts may be designated for multiple instances of the same application. That is multiple instances of one application may be simultaneously running on the same computer system. For example, a first instance may be started by a user double-clicking on an icon for the application, and while the first instance is running, the user may double-click on the icon again which starts a second instance of the application. Each instance runs in its own restricted user account which can limit the spread of viruses within the computer system 116.

In one example, the restricted user accounts 206-212 may be accounts for the same user of the user account 204. However, the restricted user accounts 206-212 were created to run the applications described above in an environment where the applications have access to limited resources instead of all the resources of the user account 204. Thus, a virus infecting any of the applications is substantially confined to the resources available to the infected application. Additionally, some of the restricted user accounts 208-212 include contact information 112 shown in FIG. 1. Thus, particular viruses infecting applications running in these restricted user accounts 208-212 may only send messages to an alert computer, such as the alert computer 118 shown in FIG. 1, thus triggering a response.

The principle of least authority (hereinafter referred to as POLA) may be implemented by controlling an application's access to resources within a computer system. POLA, in general, gives a person or thing the least authority it needs to perform a task. By implementing POLA in the computer system, the system controls an application's access, through controlling access permissions, to resources within the computer system. In one example, the system may control an application's access to the resources such that the application may have access to only the executable file needed to run the application and any other file necessary to complete a task. By controlling the access to resources, the computer system can be shielded from an application infected with a virus. One example of limiting an application's permissions to resources may include creating a restricted user account and confining the application to run within the restricted user account.

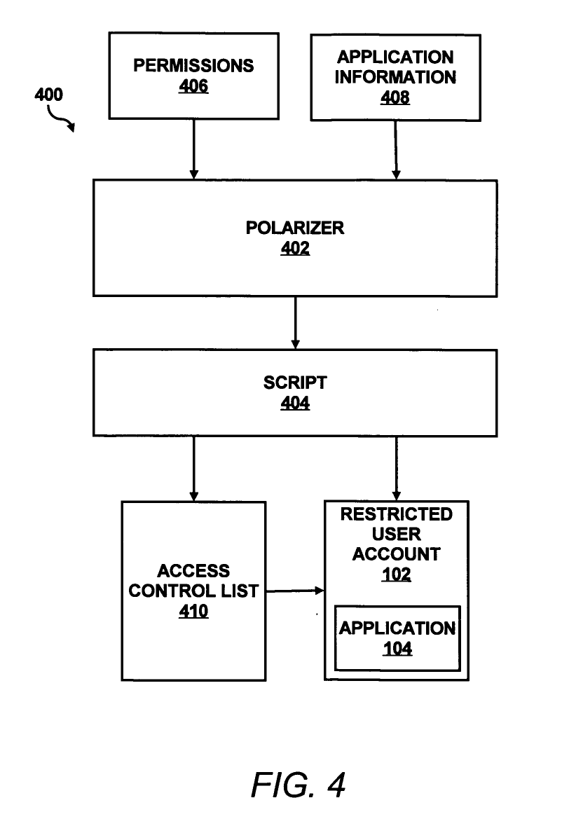

Referring now to FIG. 4, there is shown a block diagram of a system 400 for confining an application. The system 400 includes a polarizer 402 for accepting as inputs permissions 406 and application information 408. The permissions 406 may be input by a user selecting a resource or resources that will available to the application 104 through the restricted user account 102. The application information 408 may include the name and location of an executable file. The polarizer 402 accepts the permissions 406 and application information 408 and creates a script 404. The script 404 may be an executable file or macro that is configured to run on the computer system. The script 404, when executed, creates the restricted user account 102, adds to an access control list 410 a list of resources available to the restricted user account 102 and launches the application 104 in the user account 102. The application 104 then runs in the restricted user account 102 on the computer system.

As an alternative to using the polarizer 402, the script 404 may be a generic script that takes as input the name of a resource (that is, a file to be edited or used by the application) and the application information 408 and then runs the application 104 within the restricted user account 102 using a predetermined set of permissions. In this manner, the script 404 may provide the application 104 with a predetermined set of permissions by confining the application 104 to run within the restricted user account 102.

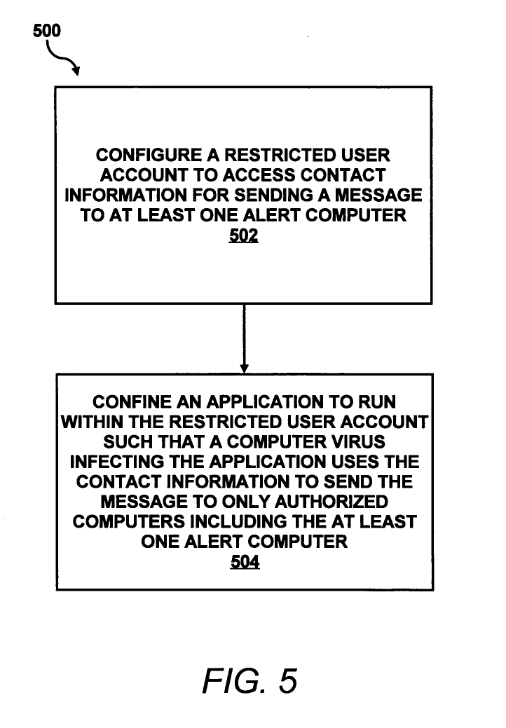

FIG. 5 shows a flow diagram of an operational mode 500 of an example of a system for detecting a computer virus. The following description of the operational mode 500 is made with reference to the system 100 illustrated in FIG. 1, and thus makes reference to the elements cited therein. The following description of the operational mode 500 is one manner in which the system 100 may be implemented. In this respect, it is to be understood that the following description of the operational mode 500 is but one manner of a variety of different manners in which such a system may be operated.

In the operational mode 500, the restricted user account 102 is configured to include permission to access the contact information 112 for sending messages to the alert computer 118 at step 502. The application 104 is confined to run within the restricted user account 102 at step 504. In this manner, a computer virus infecting the application uses the contact information 112 to send the message to only authorized computers including the alert computer 118.

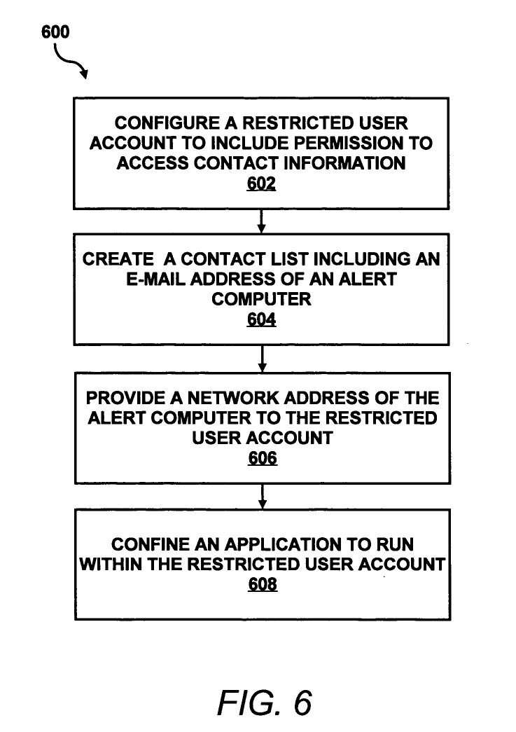

FIG. 6 shows a flow diagram of an operational mode 600 of another example of a system for detecting a computer virus. The following description of the operational mode 600 is made with reference to the system 100 illustrated in FIG. 1, and thus makes reference to the elements cited therein. The following description of the operational mode 600 is one manner in which the system 100 may be implemented. In this respect, it is to be understood that the following description of the operational mode 600 is but one manner of a variety of different manners in which such a system may be operated.

In the operational mode 600, the restricted user account 102 is configured to include permission to access contact information 112 for sending messages to the alert computer 118 at step 602. A contact list, which includes one or more e-mail addresses of only the alert computer 118 and possibly other alert computers, is created and stored in a location available to the restricted user account 102 at step 604. Network addresses of the alert computer 118 are provided in the contact information 112 and stored in a location available to the network connection system 108 of the restricted user account 102 at step 606. The application 104 is confined to run within the restricted user account 102 at step 608. In this manner, the application 104 may only send messages to the alert computer 118 using the contact information 112.

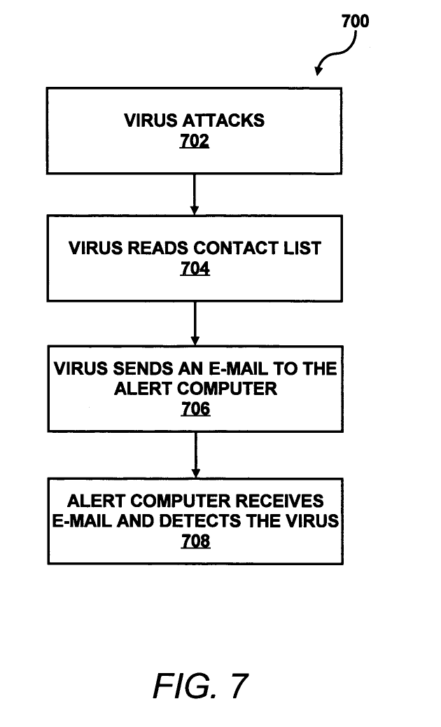

FIG. 7 shows a flow diagram of an operational mode 700 of another example of a system for detecting a computer virus. The following description of the operational mode 700 is made with reference to the system 100 illustrated in FIG. 1, and thus makes reference to the elements cited therein. The following description of the operational mode 700 is one manner in which the system 100 may be implemented. In this respect, it is to be understood that the following description of the operational mode 700 is but one manner of a variety of different manners in which such a system may be operated.

In the operational mode 700, a virus attacks the application 104 running in the restricted user account 102 at step 702. The virus, acting through the application 104 or separately from the application 104, reads one or more e-mail addresses from the contact list in the contact information 112 that is available to the restricted user account 102 at step 704. The virus then sends, acting through the application 104 or separately from the application 104, one or more e-mails to the alert computer 118 at step 706. That is, if virus has appended the application 104 with code or a program, the virus may act through the application. Alternatively, the application 104 may have been infected in such a manner that starting the application 104 launches a virus that runs separately from the application 104. The alert computer 118 receives the e-mail and detects the virus through one of a variety of mechanisms at step 708. Detection of the virus may be achieved simply by receiving the e-mail, that is, receipt of the e-mail signifies that a virus has attacked and thus is detected. Alternatively, the alert computer 118 may be configured to analyze incoming e-mail to determine if the e-mail contain a virus or may be configured to treat all incoming messages as infected with a virus. If one of the messages contains a virus, the alert computer 118 may be configured to notify an authority or multiple authorities, such as, a network administrator, software engineer or any other person who would benefit from knowing about a virus attempting to propagate. Alternatively, the alert computer 118 may be configured to take appropriate action or to notify another computer system or application to take appropriate action, such as, notifying a user that the application 104 is infected with a virus, directing the user to an anti-virus software site or advertisement, attempting to remove the virus remotely or directing the user to run an anti-virus software program.

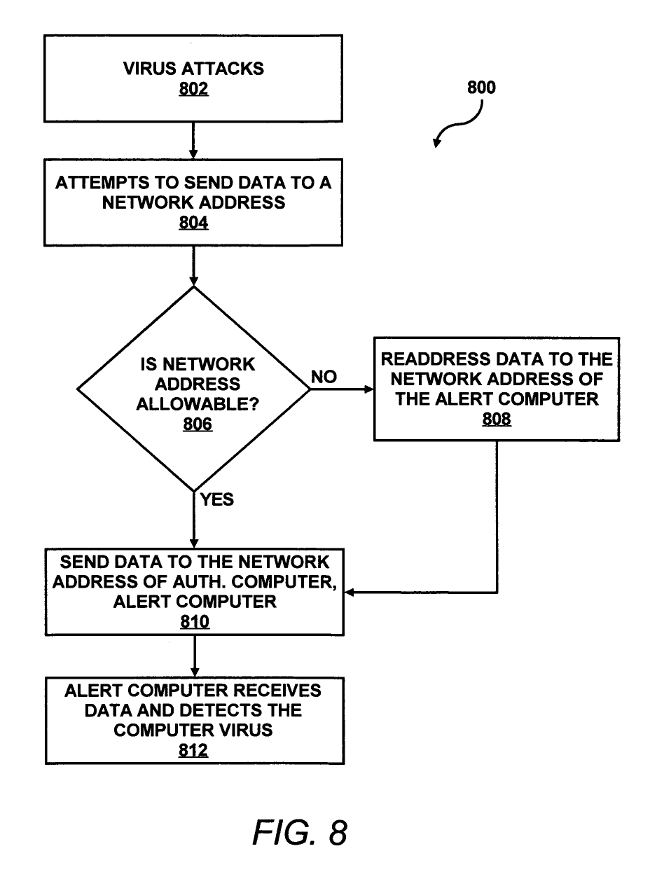

FIG. 8 shows a flow diagram of an operational mode 800 of another example of a system for detecting a computer virus. The following description of the operational mode 800 is made with reference to the system 100 illustrated in FIG. 1, and thus makes reference to the elements cited therein. The following description of the operational mode 800 is one manner in which the system 100 may be implemented. In this respect, it is to be understood that the following description of the operational mode 800 is but one manner of a variety of different manners in which such a system may be operated.

In the operational mode 800, a virus attacks the application 104 running in the restricted user account 102 at step 802. The virus, acting through the application 104 or separately from the application 104, attempts to send data to a network address at step 804. The re-addresser 110 examines the message to determine if the network address is allowable at step 806. The allowable network addresses is the one or more network addresses listed in the contact information 112 available to the restricted user account 104. The allowable network addresses include network addresses of authorized computers, which includes the network address of the alert computer 118. If no, the re-addresser 110 readdresses the data to the network address of the alert computer 118 using the contact information 112 at step 808 and then sends the data to the alert computer 118 at step 110. If yes, the re-addresser 110 allows the data to be sent to the alert computer 118 or any other authorized computer at step 810. Alternatively, the re-addresser 110 may readdress all messages without checking the network address in the case wherein all authorized computers are alert computers The alert computer 118 receives the message and detects the virus through one of a variety of mechanisms at step 812. Detection of the virus may be achieved simply by receiving the message, that is, receipt of the message signifies that a virus has attacked and thus is detected. Alternatively, the alert computer 118 may be configured to analyze incoming messages to determine if the message was delivered by a virus or contains a virus. If one of the messages contains, or was delivered by, a virus, the alert computer 118 may be configured to notify an authority or multiple authorities, such as, a network administrator, software engineer or any other person who would benefit from knowing about a virus attempting to propagate. Alternatively, the alert computer 118 may be configured to take appropriate action or to notify another computer system or application to take appropriate action, such as, notifying a user that the application 104 is infected with a virus, directing the user to an anti-virus software site or advertisement, attempting to remove the virus remotely or directing the user to run an anti-virus software program.

Some of the steps illustrated in the operational modes 500, 600, 700 and 800 may be contained as a utility, program, subprogram, in any desired computer accessible medium. In addition, the operational modes 500, 600, 700 and 800 may be embodied by a computer program or a plurality of computer programs, which may exist in a variety of forms both active and inactive in a single computer system or across multiple computer systems. For example, they may exist as software program(s) comprised of program instructions in source code, object code, executable code or other formats for performing some of the steps. Any of the above may be embodied on a computer readable medium, which include storage devices and signals, in compressed or uncompressed form.

Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

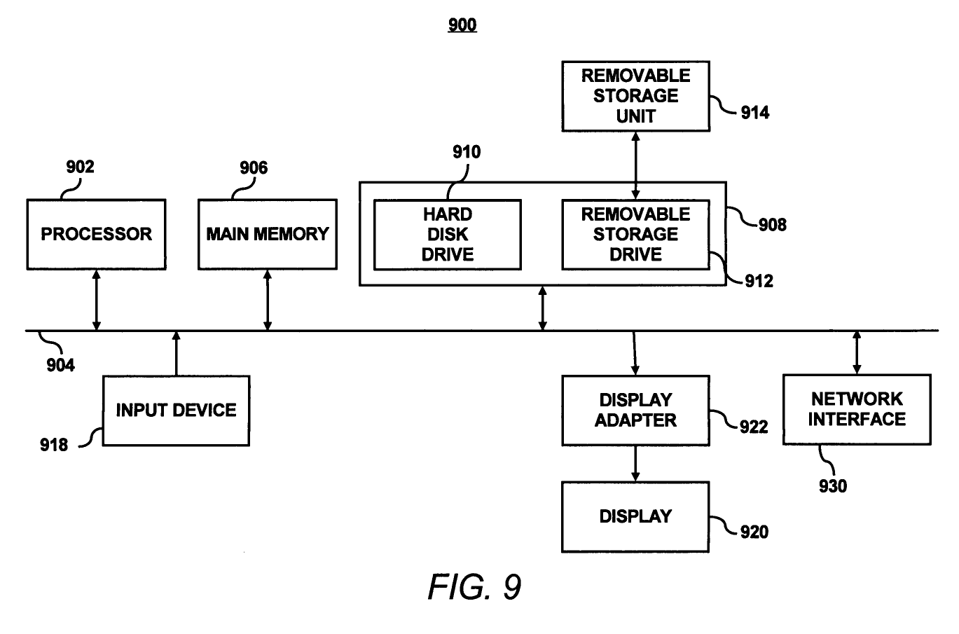

FIG. 9 illustrates an exemplary block diagram of a computer system 900 that may run the application 104 shown in FIG. 1. The computer system 900 includes one or more processors, such as processor 902, providing an execution platform for executing software, such as the application 104, the e-mail system 106 and the network connection system 108 within the restricted user account 102. The processor 902 may also execute an operating system (not shown) for running the application, creating and managing restricted user accounts, sending messages to other computers including the alert computer 116 by way of network interface 930 in addition to performing operating system tasks.

Commands and data from the processor 902 are communicated over a communication bus 904. The computer system 900 also includes a main memory 906, such as a Random Access Memory (RAM), where software may be executed during runtime, and a secondary memory 908. The secondary memory 908 includes, for example, a hard disk drive 910 and/or a removable storage drive 912, representing a floppy diskette drive, a magnetic tape drive, a compact disk drive, etc., or a nonvolatile memory where a copy of the software may be stored. Applications and some resources, such as files, may be stored in the secondary memory 908 and transferred to the main memory 906 during run time. Additionally, the application 104 and contact information 112, shown in FIG. 1, may be stored in the same manner. The secondary memory 908 may also include ROM (read only memory), EPROM (erasable, programmable ROM), EEPROM (electrically erasable, programmable ROM).

A user interfaces with the computer system 900 with one or more input devices 918, such as a keyboard, a mouse, a stylus, and the like. The display adaptor 922 interfaces with the communication bus 904 and the display 920 and receives display data from the processor 902 and converts the display data into display commands for the display 920. The user interacts with the application 104 through the use of the input devices 918 and display 920. A network interface 930 is provided for communicating with other nodes including the alert computer 116 via a network.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which intended to be defined by the following claims and their equivalents in which all terms are meant in their broadest reasonable sense unless otherwise indicated.

What is claimed is:

1. A method comprising:
configuring a restricted user account to include permission to access contact information for sending a message to at least one alert computer;
confining an application to run within the restricted user account, such that a computer virus infecting the application uses the contact information to send the message to only authorized computers including the at least one alert computer.

2. The method of claim 1, further comprising:
creating a contact list with only the contact information for the at least one alert computer, wherein the contact information includes at least one email address for the at least one alert computer.

3. The method of claim 2, wherein confining an application to run within the restricted user account further comprises:
confining the application to run within the restricted user account, such that the application running in the restricted user account is operable to send an email using the at least one email address in the contact list.

4. The method of claim 1, further comprising:
storing the contact information for the at least one alert computer in a network connection system.

5. The method of claim 4, wherein configuring a restricted user account to include permission to access contact information further comprises:
configuring a restricted user account to include permission to send a message via the network connection system to a computer authorized to receive messages.

6. The method of claim 5, further comprising:
readdressing the message sent by the application via the network connection system with the contact information stored in the network connection system if the message is not addressed to one of the authorized computers.

7. The method of claim 6, wherein the contact information comprises at least one network address for the at least one of the authorized computer systems.

8. The method of claim 1, wherein configuring a restricted user account further comprises:
limiting permissions of the restricted user account to minimize spreading of a virus attacking the application running in the restricted user account.

9. The method of claim 8, wherein limiting permissions further comprises:
granting the restricted user account only a set of permissions needed for the application to run.

10. The method of claim 1, wherein the authorized computers includes a plurality of predetermined computers.

11. The method of claim 11, wherein the plurality of predetermined computers includes only alert computers.

12. A system comprising:
means for running an application within a restricted user account;
means for providing an e-mail address of only the at least one alert computer to the application;
means for addressing an e-mail to the at least one alert computer using the contact list; and
means for sending the e-mail from the application to the at least one alert computer, wherein the email provides an alert, on the at least one alert computer, of a computer virus infecting the application.

13. The system of claim 12, further comprising contact list means for storing the e-mail address of the at least one alert computer.

14. A system comprising:
means for running an application within a restricted user account;
means for providing a network address of only at least one alert computer to the application;
means for addressing a message to the at least one alert computer using the network address; and
means for sending the message from the application to the at least one alert computer, wherein the message provides an alert, on the at least one alert computer, of a computer virus infecting the application.

15. The system of claim 14, further comprising means for readdressing the message to the network address of the at least one alert computer.

16. A computer readable medium on which is embedded one or more computer programs, said one or more computer programs implementing a method for detecting a computer virus with an alert computer, said one or more computer programs comprising a set of instructions for:
confining an application to run within a restricted user account;
providing the restricted user account with contact information for the alert computer; and
sending a message from the application to the alert computer using the contact information.

17. The computer readable storage medium according to claim 16, wherein the one or more computer programs comprising a set of instructions for providing the restricted user account with contact information further comprises a set of instructions for providing a contact list including only at least one e-mail address for at least one alert computer to the restricted user account.

18. The computer readable storage medium according to claim 17, wherein the one or more computer programs comprising a set of instructions for sending a message further comprises a set of instructions for sending an e-mail to the alert computer using an e-mail address in the contact list.

19. The computer readable storage medium according to claim 16, wherein the one or more computer programs comprising a set of instructions for providing the restricted user account with contact information further comprises a set of instructions for providing a network address for the alert computer to the restricted user account.

20. The computer readable storage medium according to claim 19, wherein the one or more computer programs comprising a set of instructions for sending a message further comprises a set of instructions for readdressing the message to the network address of the alert computer and sending the message to the alert computer using the network address.

21. A computer system comprising:
a restricted user account;
a contact list having at least one e-mail address for only at least one alert computer, wherein the restricted user account has permission to access the contact list; and
an application running in the restricted user account, the application configured to use the contact list to send an e-mail to only authorized computers including the at least one alert computer.

22. The system of claim 21, wherein the authorized computer includes a plurality of predetermined computers.

23. The system of claim 22, wherein the plurality of predetermined computers includes only alert computers.

24. A computer system comprising:
a restricted user account;
contact information having at least one network address for only at least one alert computer, wherein the restricted user account has permission to access the contact information ; and
an application running in the restricted user account, the application configured to use the contact information to send a message to only authorized computers including the at least one alert computer.

25. The system of claim 24, further comprising a re-addresser configured to determine if the message is directed to another network address and, if so, to send the message to the network address of the at least one alert computer.

26. The system of claim 25, wherein the authorized computer includes a plurality of predetermined computers.

27. The system of claim 26, wherein the plurality of predetermined computers includes only alert computers.
